(19) United States
(12) Patent Application Publication
(10) Pub. No.: US 2024/0044027 A1
(43) Pub. Date: Feb. 8, 2024

(54) IRIDIUM-CONTAINING CATALYST FOR WATER ELECTROLYSIS

(71) Applicants: Heraeus Deutschland GmbH & Co. KG, Hanau (DE); TECHNISCHE UNIVERSITÄT MÜNCHEN, München (DE)

(72) Inventors: Christian GEBAUER, Hanau (DE); Martina KEMMER, Hanau (DE); Hubert GASTEIGER, München (DE); Maximilian BERNT, München (DE); Alexandra HARTIG-WEIß, Heilsbronn (DE); Jan BYRKNES, Bad Vilbel (DE); Christian EICKES, Frankfurt am Main (DE); Alessandro GHIELMI, Frankfurt am Main (DE)

(21) Appl. No.: 18/256,101

(22) PCT Filed: Dec. 22, 2021
(86) PCT No.: PCT/EP2021/087172

§ 371 Date: Jun. 6, 2023

(30) Foreign Application Priority Data
Dec. 23, 2020 (EP) 20217035.3

(51) Int. Cl. C25B 11/081; C25B 11/067; C25B 1/04; C25B 11/054; C25B 11/037

(52) U.S. Cl. CPC C25B 11/081; C25B 11/067; C25B 1/04; C25B 11/054; C25B 11/037

(57) ABSTRACT

The invention relates to a particulate catalyst, containing: —a support material, —an iridium-containing coating which is provided on the support material and which contains iridium oxide, an iridium hydroxide, or an iridium hydroxide oxide, wherein the support material has a BET surface area ranging from 2 m²/g to 50 m²/g, and the iridium content of the catalyst satisfies the following condition: (1.505 (g/m²)×BET)/(1+0.0176 (g/m²)×BET)≤Ir-G≤(4.012 (g/m²)×BET)/(1+0.0468 (g/m²)×BET), where BET is the BET surface area of the support material, in m²/g, and Ir-G is the iridium content, in wt. %, of the catalyst.

The present invention relates to an iridium-containing catalyst for the oxygen evolution reaction in water electrolysis.

Hydrogen is considered to be an energy carrier of the future, since it enables sustainable energy storage, is available over the long term, and can also be produced using regenerative energy technologies.

Steam reforming is currently the most common method for producing hydrogen. In steam reforming, methane and water vapor are reacted to produce hydrogen and CO. Water electrolysis represents a further variant of hydrogen production. Hydrogen of high purity can be obtained via water electrolysis.

There are various methods of water electrolysis, especially alkaline water electrolysis, acidic water electrolysis using a polymer electrolyte membrane (“PEM”; PEM water electrolysis) and high-temperature solid oxide electrolysis.

A water electrolysis cell contains a half-cell with an electrode at which the oxygen evolution reaction (“OER”) takes place, as well as a further half-cell with an electrode at which the hydrogen evolution reaction (“HER”) takes place. The electrode at which the oxygen evolution reaction takes place is referred to as the anode.

An overview of water electrolysis technology, in particular of PEM water electrolysis, can be found, for example, in M. Carmo et al., International Journal of Hydrogen Energy, 38, 2013, pp. 4901-4934; and V. Himabindu et al., Materials Science for Energy Technologies, 2, 2019, pp. 442-454.

In a polymer-electrolyte membrane water electrolysis cell (hereinafter also referred to as a PEM water electrolysis cell), the polymer membrane functions as a proton transport medium and electrically insulates the electrodes from each other. The catalyst compositions for the oxygen evolution reaction and the hydrogen evolution reaction are applied, for example, as an anode and a cathode to the front and rear sides of the membrane (“catalyst-coated membrane CCM”), thereby obtaining a membrane-electrode assembly (“MEA”).

The oxygen evolution reaction taking place at the anode of a PEM water electrolysis cell can be represented by the following reaction equation:

2H₂O→4H⁺+O₂+4e⁻

Due to its complex reaction mechanism, the oxygen evolution reaction exhibits slow reaction kinetics, which is why significant overpotential at the anode is required in order to achieve sufficiently high conversion rates. In addition, the oxygen evolution reaction proceeds under highly acidic conditions (i.e. low pH).

Efficient operation of a water electrolysis cell requires the presence of catalysts. Since the oxygen evolution reaction at the anode proceeds under highly corrosive conditions (low pH, significant overvoltage), suitable catalyst materials are in particular noble metals such as ruthenium and iridium and oxides thereof.

The catalytically active metals or metal oxides can optionally be present on a support material in order thereby to increase the specific surface area of the catalyst material.

In the case of the support materials, too, only those materials which have a sufficiently high stability under the highly corrosive conditions of the oxygen evolution reaction are suitable, for example transition metal oxides such as TiO₂ or oxides of certain main group elements, such as Al₂O₃. However, many of these oxide-based support materials are electrically non-conductive, which has a disadvantageous effect on the efficiency of the oxygen evolution reaction and thus also of the water electrolysis.

An overview of catalysts for the oxygen evolution reaction under acidic conditions (i.e., at the anode of a PEM water electrolysis cell) can be found, for example, in P. Strasser et al., Adv. Energy Mater., 7, 2017, 1601275; and F. M. Sapountzi et al., Progress in Energy and Combustion Science, 58, 2017, pp. 1-35.

WO 2005/049199 A1 describes a catalyst composition for the oxygen evolution reaction in PEM water electrolysis. This catalyst contains iridium oxide and an inorganic oxide acting as a support material. The support material comprises a BET surface area in the range from 50 m²/g to 400 m²/g and is present in the composition in an amount of less than 20% by weight. Thus, the catalyst composition comprises a high iridium content.

Iridium deposits are quite limited. In the publications by M. Bernt et al., “Analysis of Voltage Losses in PEM Water Electrolyzers with Low Platinum Group Metal Loadings”, J. Electrochem. Soc. 165, 2018, F305-F314, and M. Bernt et al., “Current Challenges in Catalyst Development for PEM Water Electrolyzers”, Chem. Ing. Tech., 2020, 92, no. 1-2, pp. 31-39, it is mentioned that a currently customary degree of loading of iridium on the anode side of the catalyst-coated membrane is approximately 2 mg of iridium per cm² of coated membrane surface, but this degree of loading must still be considerably reduced in order to enable large-scale use of PEM electrolysis based on the available amount of iridium.

M. Bernt et al., J. Electrochem. Soc. 165, 2018, F305-F314, describe the production of catalyst-coated membranes using a commercially available catalyst composition comprising a TiO₂-supported IrO₂. The catalyst composition contains iridium (in the form of IrO₂) in an amount of 75% by weight. In order to obtain an anode which has as low a surface-based degree of iridium loading as possible, the layer thickness of the anode was reduced. Surface-based degrees of iridium loading in the range of 0.20-5.41 mg of iridium/cm² of membrane were produced and tested for their efficiency in water electrolysis. While at degrees of loading of 1-2 mg of iridium/cm² of membrane good results were still obtained, degrees of loading of less than 0.5 mg of iridium/cm² of membrane led to a significant worsening of the efficiency of the water electrolysis due to the low layer thickness of the anode and the resulting inhomogeneous electrode layer. This publication therefore proposes changing the structure or morphology of the catalyst composition so as to result in a lower iridium packing density in the anode layer and to thereby achieve a reduced degree of iridium loading, of less than 0.5 mg of iridium/cm² of coated membrane surface, for the same anode layer thickness (e.g. 4-8 μm).

M. Bernt et al., Chem. Ing. Tech., 2020, 92, no. 1-2, pp. 31-39, mention that a possible approach for a lower iridium packing density in the anode consists in using a support material of high specific surface area (i.e. high BET surface area) and in dispersing the catalytically active metallic iridium or the iridium oxide as finely as possible on this support material. In this context, it is mentioned in the publication that many of the customary support materials of sufficiently high stability, e.g. TiO₂, are electrically non-conductive and therefore a relatively large amount of Ir or IrO₂ (>40% by weight) is required in the catalyst composition in order to generate as contiguous as possible a network of Ir or IrO₂ nanoparticles on the surface of the electrically non-conductive support material. The publication also describes, as a possible approach for solving this, that the iridium oxide can be dispersed on an electrically conductive support material, for example an antimony-doped tin oxide.

EP 2 608 297 A1 describes a catalyst composition for water electrolysis which contains an inorganic oxide acting as a support material and an iridium oxide dispersed on this support material. The oxide-based support material is present in the composition in an amount of 25-70% by weight and comprises a BET surface area in the range from 30-200 m²/g.

C. Van Pham et al., Applied Catalysis B: Environmental, 269, 2020, 118762, describe a catalyst for the oxygen evolution reaction of water electrolysis, which catalyst comprises a core-shell structure, wherein TiO₂ forms the core and IrO₂ forms the shell. The core-shell particles contain 50% by weight of IrO₂. Using X-ray diffraction and the Scherrer equation, an average crystallite size of 10 nm is determined for the IrO₂ shell. Catalyst-coated membranes are produced, the anode of which has a surface-based degree of iridium loading of 1.2 mg of iridium/cm² of membrane or 0.4 mg of iridium/cm² of membrane.

EP 2 608 298 A1 describes a catalyst containing (i) a support material with a core-shell structure and (ii) metallic nanoparticles dispersed on this core-shell support. The catalyst composition is used for fuel cells.

An object of the present invention is to provide a catalyst for the oxygen evolution reaction in acidic water electrolysis (“PEM water electrolysis”), by means of which an anode in a membrane electrode unit can be produced, said anode having surface-based iridium loading which is as low as possible (i.e. as small as possible an amount of iridium per cm² of membrane), while still exhibiting high activity with respect to the oxygen evolution reaction.

According to a first aspect of the present invention, the object is achieved by a particulate catalyst containing
a support material,
an iridium-containing coating which is provided on the support material and which contains an iridium oxide, an iridium hydroxide, or an iridium hydroxide oxide, or a mixture of at least two of these iridium compounds, and has an average layer thickness in the range from 1.5 nm to 5.0 nm,
wherein the catalyst comprises an iridium content of at most 50% by weight.

The catalyst according to the invention contains a relatively small amount (at most 50% by weight) of iridium, which is present as iridium oxide, iridium hydroxide or iridium hydroxide oxide in the form of a coating on the particulate support material. In the context of the first aspect of the present invention, it has been found that, in the case of an average layer thickness of this iridium-containing coating on the particles of the support material in the range from 1.5 nm to 5.0 nm, a catalyst is obtained from which an anode can be produced, which anode has a very low surface-based iridium loading (e.g. less than 0.4 mg of iridium per cm²), while still exhibiting high activity with respect to the oxygen evolution reaction. The layer thickness can be adjusted by the amount of iridium oxide, iridium hydroxide or iridium hydroxide oxide which is deposited on the support material, and by the BET surface area of the support material. The higher the BET surface area of the support material for a certain amount of applied iridium oxide, iridium hydroxide or iridium hydroxide oxide, the lower the layer thickness of the iridium-containing coating will be.

The iridium-containing coating preferably has a relatively uniform layer thickness. For example, the average layer thickness varies locally by a factor of at most 2. The relative standard deviation from the average layer thickness is preferably at most 35%. As is generally known, the relative standard deviation SDᵣₑₗ (in %), sometimes also referred to as coefficient of variation, is given by the following relationship:

SDᵣₑₗ=[SD/M]×100
where
M is the mean of the measured variable, i.e. in this case the average layer thickness in
nm, and
SD is the standard deviation, in nm, from the average layer thickness.

The (absolute) standard deviation is given, as is known, by the square root of the variance.

According to a second aspect of the present invention, the object is achieved by a particulate catalyst containing
a support material,
an iridium-containing coating which is provided on the support material and which contains an iridium oxide, an iridium hydroxide, or an iridium hydroxide oxide,
wherein the support material comprises a BET surface area in the range from 2 m²/g to 50 m²/g and the iridium content of the catalyst satisfies the following condition: (1.505 (g/m²)×BET)/(1+0.0176 (g/m²)×BET)≤Ir-G≤(4.012 (g/m²)×BET)/(1+0.0468 (g/m²)×BET)
where
BET is the BET surface area, in m²/g, of the support material, and
Ir-G is the iridium content, in % by weight, of the catalyst.

The use of a support material with a relatively low BET surface area (at most 50 m²/g) makes it possible to reduce the iridium content of the catalyst. In the context of the present invention, it has surprisingly been found that an improved compromise between an iridium content which is as low as possible and an activity which is as high as possible with respect to the oxygen evolution reaction can be achieved when the iridium content of the catalyst is matched to the BET surface area of the support material such that the above-mentioned condition is satisfied.

If, for example, a support material with a BET surface area of 10 m²/g is used, this means, using the above-mentioned condition, that an iridium content in the range of 13-27% by weight should be selected for the catalyst.

Unless indicated otherwise, the following statements apply both to the catalyst according to the first aspect and to the catalyst according to the second aspect of the present invention.

The catalyst preferably does not contain any metallic iridium (i.e. iridium in the 0 oxidation state). The iridium is preferably exclusively present as iridium in the +3 oxidation state (iridium(III)) and/or as iridium in the +4 oxidation state (iridium(IV)). The oxidation state of the iridium and thus the absence of iridium(0) and the presence of iridium(III) and/or iridium(IV) can be verified by XPS (X-ray photoelectron spectroscopy).

The catalyst preferably comprises iridium in an amount of at most 40% by weight, more preferably at most 35% by weight. For example, the catalyst contains iridium in an amount of 5% by weight to 40% by weight, more preferably 5% by weight to 35% by weight.

The iridium-containing coating preferably has an average thickness in the range from 1.5 nm to 4.0 nm, more preferably 1.7 nm to 3.5 nm.

In one exemplary embodiment, the iridium-containing coating has an average thickness in the range from 1.7 nm to 3.5 nm and the iridium content of the catalyst is at most 40% by weight.

The BET surface area of the support material is preferably 2 m²/g to 40 m²/g, more preferably 2 m²/g to <10 m²/g, even more preferably 2 m²/g to 9 m²/g.

In a preferred embodiment, the iridium content of the catalyst satisfies the following condition: (1.705 (g/m²)×BET)/(1+0.0199 (g/m²)×BET)≤Ir-G≤(3.511 (g/m²)×BET)/(1+0.0410 (g/m²)×BET)
where
BET is the BET surface area, in m²/g, of the support material, and
Ir-G is the iridium content, in % by weight, of the catalyst.

Even more preferably, the iridium content of the catalyst satisfies the following condition: (1.805 (g/m²)×BET)/(1+0.0211 (g/m²)×BET)≤Ir-G≤(3.009 (g/m²)×BET)/(1+0.0351 (g/m²)×BET)
where
BET is the BET surface area, in m²/g, of the support material, and
Ir-G is the iridium content, in % by weight, of the catalyst.

The iridium-containing coating preferably comprises an iridium hydroxide oxide. In addition to oxide anions, an iridium hydroxide oxide also contains hydroxide anions and can be represented, for example, by the following formula: IrO(OH)x; 1≤x<2.

For example, in the iridium-containing coating there is an atomic ratio of iridium(IV) to iridium(III), determined by means of X-ray photoelectron spectroscopy (XPS), of at most 4.7/1.0. For example, the atomic iridium(IV)/iridium(II) ratio in the iridium-containing layer is in the range from 1.0/1.0 to 4.7/1.0. This can lead to a further improvement in the electrochemical activity of the catalyst. In order to achieve an advantageous compromise between high electrochemical activity and high electrical conductivity, it may be preferred for the atomic iridium(IV)/iridium(III) ratio in the iridium-containing layer to be in the range from 1.9/1.0 to 4.7/1.0, more preferably 2.5/1.0 to 4.7/1.0. The atomic iridium(IV)/iridium(II) ratio can be adjusted via the temperature of a thermal treatment of the catalyst. Thermal treatment of the catalyst at high temperature favors high values for the iridium(IV)/iridium(II) ratio. Preferred temperatures for a thermal treatment of the catalyst are also specified below.

The catalyst preferably contains no metallic noble metal (such as platinum, palladium, iridium, rhodium, ruthenium, osmium, silver or gold). Metallic noble metal means a noble metal in the 0 oxidation state. The absence of metallic noble metals can be verified by XPS.

Optionally, the iridium-containing coating can also comprise ruthenium in the +3 oxidation state (Ru(III)) and/or in the +4 oxidation state (Ru(IV)).

Suitable support materials to which the iridium-containing coating can be applied are known to the person skilled in the art. For example, the support material is an oxide of a transition metal (for example a titanium oxide (e.g. TiO₂), a zirconium oxide (e.g. ZrO₂), a niobium oxide (e.g. Nb₂O₅), a tantalum oxide (e.g. Ta₂O₅) or a cerium oxide), an oxide of a main group metal (e.g. an aluminum oxide such as Al₂O₃), SiO₂ or a mixture of two or more of the aforementioned support materials. In a preferred embodiment, the support material is a titanium oxide.

The support material is usually a particulate support material.

For the electrochemical activity of the catalyst, it may be advantageous to avoid a longer thermal treatment at high temperature. In other words, if the loaded support material is dried at a moderate temperature and a subsequent high-temperature calcination of the material is dispensed with, or at least the duration of the thermal treatment at a higher temperature is kept relatively short, this material will exhibit a high level of catalytic activity in the oxygen evolution reaction under acidic conditions.

For example, during its production, the catalyst is not subjected to thermal treatment at a temperature of more than 250° C. for a duration of more than 1 hour.

For example, during its production, the catalyst is dried at a temperature of at most 250° C., more preferably at most 200° C., and is not subjected to any further thermal treatment after the drying.

If the catalyst is not subjected to any thermal post-treatment during its production, this may result in the catalyst having a rather low electrical conductivity. In the anode of a water electrolysis cell, the catalyst-containing coating present on the membrane can for example adjoin a porous transport layer (PTL). Porous transport layers are made, for example, of titanium, it being possible for a thin oxide layer to form on the metal. If the catalyst has a rather low electrical conductivity, this can lead to an undesired increase in the contact resistance at the interface between the catalyst-containing coating and the porous transport layer and thus adversely affect the efficiency of the water electrolysis cell. The contact resistance between the catalyst-containing coating and the porous transport layer made of titanium can be reduced if, for example, a noble metal (e.g. platinum) is applied to the porous transport layer, so that the catalyst-containing coating adjoins this metallic platinum layer.

In order to improve the electrical conductivity of the catalyst and thus to avoid applying a noble metal layer to the porous transport layer in the water electrolysis cell, it may be advantageous if the catalyst has been subjected to a thermal post-treatment at a somewhat higher temperature during its production.

An advantageous compromise between sufficiently high electrical conductivity and high electrochemical activity of the catalyst can be achieved, for example, if, during its production, the catalyst has been subjected to a thermal treatment at a temperature of more than 250° C., e.g. >250° C. to 550° C., more preferably 300° C. to 450° C., even more preferably 300° C. to 380° C.

The thermal treatment can take place, for example, in an oxygen-containing atmosphere. The thermal treatment takes place, for example, over a period of at least one hour, but preferably no more than three hours. As a result of this thermal treatment (preferably at 300-450° C., even more preferably at 300-380° C.), the electrical conductivity of the catalyst can be significantly increased compared to a non-thermally-treated catalyst (for example 50- to 100-fold), while the electrochemical activity is only moderately reduced (e.g. 1.5- to 2-fold).

For example, during its production, the catalyst is not subjected to thermal treatment at a temperature of more than 360° C. for a duration of more than 60 minutes.

The particulate catalyst preferably comprises a core-shell structure in which the support material forms the core and the iridium-containing coating forms the shell. Preferably, the core is completely enclosed by the shell.

According to a third aspect of the present invention, the object is achieved by a particulate catalyst containing
a support material that comprises a BET surface area in the range from 2 m²/g to <10 m²/g, more preferably 2 m²/g to 9 m²/g,
an iridium-containing coating which is provided on the support material and which contains an iridium oxide, an iridium hydroxide, or an iridium hydroxide oxide, or a mixture of at least two of these iridium compounds,
wherein the catalyst comprises an iridium content of 5% by weight to 20% by weight, more preferably 5% by weight to 14% by weight.

With regard to suitable support materials, reference can be made to the above statements. For example, the support material is an oxide of a transition metal (for example a titanium oxide (e.g. TiO₂), a zirconium oxide (e.g. ZrO₂), a niobium oxide (e.g. Nb₂O₅), a tantalum oxide (e.g. Ta₂O₅) or a cerium oxide), an oxide of a main group metal (e.g. an aluminum oxide such as Al₂O₃), SiO₂ or a mixture of two or more of the aforementioned support materials. In a preferred embodiment, the support material is a titanium oxide. The support material is usually a particulate support material.

With regard to preferred properties of the iridium-containing coating, reference can also be made to the above statements. The iridium-containing coating preferably comprises an iridium hydroxide oxide. In addition to oxide anions, an iridium hydroxide oxide also contains hydroxide anions and can be represented, for example, by the following formula: IrO(OH)x; 1≤x<2. For example, in the iridium-containing coating there is an atomic ratio of iridium(IV) to iridium(III), determined by means of X-ray photoelectron spectroscopy (XPS), of at most 4.7/1.0. For example, the atomic iridium(IV)/iridium(II) ratio in the iridium-containing layer is in the range from 1.0/1.0 to 4.7/1.0. This can lead to a further improvement in the electrochemical activity of the catalyst. In order to achieve an advantageous compromise between high electrochemical activity and high electrical conductivity, it may be preferred for the atomic iridium(IV)/iridium(III) ratio in the iridium-containing layer to be in the range from 1.9/1.0 to 4.7/1.0, more preferably 2.5/1.0 to 4.7/1.0. The atomic iridium(IV)/iridium(III) ratio can be adjusted via the temperature of a thermal treatment of the catalyst.

Also for the catalyst according to the third aspect of the present invention, an advantageous compromise between sufficiently high electrical conductivity and high electrochemical activity of the catalyst can be achieved, for example, if, during its production, the catalyst has been subjected to a thermal treatment at a temperature of more than 250° C., e.g. >250° C. to 550° C., more preferably 300° C. to 450° C., even more preferably 300° C. to 380° C.

It is also preferable for the catalyst according to the third aspect of the present invention not to contain any metallic noble metal (such as platinum, palladium, iridium, rhodium, ruthenium, osmium, silver or gold). Metallic noble metal means a noble metal in the 0 oxidation state. The absence of metallic noble metals can be verified by XPS.

The present invention also relates to a method for producing the above-described particulate catalyst, wherein an iridium-containing coating containing an iridium oxide, an iridium hydroxide or an iridium hydroxide oxide is deposited on a support material.

The deposition of the iridium-containing coating on the support material is carried out, for example, by means of a wet-chemical process in which an iridium oxide, iridium hydroxide or iridium hydroxide oxide is applied to a particulate support material under alkaline conditions and optionally by thermal post-treatment.

Alternatively, it is also possible to deposit the iridium-containing coating on the support material via spray pyrolysis.

For example, the catalyst is produced using a method in which
in an aqueous medium containing an iridium compound, an iridium-containing solid is deposited on a support material at a pH 9,
the support material loaded with the iridium-containing solid is separated from the aqueous medium and optionally subjected to a thermal treatment.

The support material to be coated is for example present in dispersed form in the aqueous medium. The aqueous medium contains an iridium compound, which can be precipitated as an iridium-containing solid under alkaline conditions. Such iridium compounds are known to the person skilled in the art. It is preferably an iridium(IV) or an iridium(II) compound.

As already mentioned, the layer thickness can be adjusted by the amount of iridium oxide, iridium hydroxide or iridium hydroxide oxide which is deposited on the support material, and by the BET surface area of the support material. The higher the BET surface area of the support material for a certain amount of applied iridium oxide, iridium hydroxide or iridium hydroxide oxide, the lower the layer thickness of the iridium-containing coating will be.

With regard to the BET surface area of the support material, reference can be made to the above statements. The BET surface area of the support material is preferably 2 m²/g to 40 m²/g, more preferably 2 m²/g to <10 m²/g, even more preferably 2 m²/g to 9 m²/g.

Suitable iridium(III) or iridium(IV) compounds, which precipitate as a solid under alkaline conditions in aqueous solution, are known to the person skilled in the art. For example, the iridium(III) or iridium(IV) compound is a salt (e.g., an iridium halide, such as IrC₃ or IrCl₄; a salt of which the anion is a chloro complex IrCl₆²⁻; an iridium nitrate or an iridium acetate) or an iridium-containing acid, such as H₂IrCI₆. In a preferred embodiment, the aqueous medium contains an iridium(IV) halide, in particular Ir(IV) chloride.

Optionally, a ruthenium(II) and/or ruthenium(IV) compound may also be present in the aqueous medium. This enables the deposition of an iridium-ruthenium hydroxide oxide on the support material. If a ruthenium precursor compound is present in the aqueous medium, it can, for example, be a Ru(III) or Ru(IV) salt, for example a halide, nitrate or acetate salt.

For the deposition of the iridium-containing solid on the support material, the aqueous medium preferably has a pH value ≥10, more preferably ≥11. For example, the aqueous medium has a pH value of 9-14, more preferably 10-14, or 11-14.

The aqueous medium usually contains water in a proportion of at least 50 vol. %, more preferably at least 70 vol. % or even at least 90 vol. %.

For the deposition of the iridium-containing solid on the support material, the temperature of the aqueous medium is, for example, 40° C. to 100° C., more preferably 60° C. to 80° C.

The support material can, for example, be dispersed (for example at room temperature) in an aqueous medium already containing one or more iridium(III) and/or iridium(IV) compounds but having a pH of <9. The pH of the aqueous medium is then increased to a value of ≥9 by the addition of a base, and optionally also the temperature of the aqueous medium is increased until an iridium-containing solid is deposited on the support material via a precipitation reaction. Alternatively, it is also possible, for example, to disperse the support material in an aqueous medium which as yet does not contain iridium compounds and to add an iridium(III) and/or iridium(IV) compound to the aqueous medium only after setting a suitable pH value and optionally a specific precipitation temperature.

Insofar as a ruthenium(III) and/or ruthenium(IV) compound was also present in the aqueous medium, the solid applied by the precipitation to the support material still contains ruthenium in addition to iridium. The atomic ratio of iridium to ruthenium may, for example, be in the range from 90/10 to 10/90.

The separation of the support material loaded with the iridium-containing solid from the aqueous medium takes place by methods known to the person skilled in the art (e.g. by filtration).

The support material loaded with the iridium-containing solid is dried. The dried iridium-containing solid present on the support material is for example an iridium hydroxide oxide. In addition to oxide anions, an iridium hydroxide oxide also contains hydroxide anions and can be represented, for example, by the following formula: IrO(OH)x; 1≤x<2.

The temperature and duration of a thermal treatment can be used to control whether an iridium oxide, an iridium hydroxide or an iridium hydroxide oxide is present in the coating present on the support material. High temperatures and a long duration of the thermal treatment favor the formation of an iridium oxide.

As already explained above, it may be advantageous for the electrochemical activity of the catalyst if a longer thermal treatment at high temperature is avoided during the production of the catalyst. In other words, if the loaded support material is dried at a moderate temperature and a subsequent high-temperature calcination of the material is dispensed with, or at least the duration of the thermal treatment at a higher temperature is kept relatively short, this material will exhibit a high level of catalytic activity in the oxygen evolution reaction under acidic conditions.

For example, in the method, the coated support material is not subjected to thermal treatment at a temperature of more than 250° C. for a duration of more than 1 hour. For example, in the method, the coated support material is not subjected to thermal treatment at a temperature of more than 200° C. for a duration of more than 30 minutes.

For example, the coated support material is dried at a temperature of at most 250° C., more preferably at most 200° C., and is not subjected to any further thermal treatment after the drying.

As also already explained above, the electrical conductivity of the iridium-containing coating present on the support material, and thus of the catalyst, can be improved if a thermal post-treatment takes place at a somewhat higher temperature. An advantageous compromise between sufficiently high electrical conductivity and high electrochemical activity of the catalyst can be achieved, for example, if the coated support material is subjected to a thermal treatment at a temperature of more than 250° C., e.g. >250° C. to 550° C., more preferably 300° C. to 450° C., even more preferably 300° C. to 380° C. The thermal treatment can take place, for example, in an oxygen-containing atmosphere. The thermal treatment takes place, for example, over a period of at least one hour, but preferably no more than three hours.

The present invention further relates to a particulate catalyst obtainable according to the method described above.

The present invention further relates to a composition containing
the above-described catalyst and
an ionomer, in particular a sulfonic acid group-containing ionomer (e.g. a sulfonic acid group-containing fluorinated ionomer).

Suitable ionomers are known to the person skilled in the art. For example, the sulfonic acid group-containing fluorinated ionomer is a copolymer which contains, as monomers, a fluoroethylene (e.g. tetrafluoroethylene) and a sulfonic acid group-containing fluorovinyl ether (e.g. a sulfonic acid group-containing perfluorovinyl ether). An overview of these ionomers can be found, for example, in the following publication: A. Kusoglu and A. Z. Weber in Chem. Rev., 2017, 117, p. 987-1104.

The composition is, for example, an ink containing a liquid medium in addition to the catalyst and the ionomer. The liquid medium contains, for example, one or more short-chain alcohols (e.g. methanol, ethanol or n-propanol or a mixture of at least two of these alcohols). The catalyst is present in the ink, for example, at a concentration of 5-60% by weight, more preferably 10-50% by weight or 20-40% by weight. The ionomer is present in the ink, for example, at a concentration of 5-50% by weight, more preferably 10-30% by weight.

The composition can also be present as a solid. For example, the anode of a water electrolysis cell contains this composition.

The present invention further relates to the use of the above-described catalyst or of the above-described composition as an anode for water electrolysis. The oxygen evolution reaction takes place at the anode. The water electrolysis is preferably a PEM water electrolysis, i.e. the oxygen evolution reaction preferably takes place under acidic conditions.

Measuring Methods

The following measuring methods were used within the context of the present invention:

Average Thickness of the Iridium-Containing Coating on the Support Material

The average thickness of the iridium-containing coating on the support material was determined by TEM (transmission electron microscopy).

A few μg of the material to be investigated were suspended in ethanol. A drop of the suspension was subsequently pipetted onto a perforated carbon film-coated Cu platelet (Plano, 200 mesh) and dried. The layer thickness measurements were taken at a magnification of 500,000×. By means of parallel EDX elemental analysis of an element (e.g. Ti) present in the support material and of Ir, the TEM image shows which regions on the support material particles contain iridium.

The thickness of the iridium-containing coating was determined on at least two TEM images in each case at at least 5 points on the TEM image. Each TEM image shows several particles. The arithmetic mean of these layer thicknesses gave the average thickness of the iridium-containing coating.

The relative standard deviation SDᵣₑₗ (in %), sometimes also referred to as coefficient of variation, from the average layer thickness is given, as is known, from the following relationship:

SDᵣₑₗ=[SD/M]×100
where
M is the average layer thickness in nm, and
SD is the standard deviation, in nm, from the average layer thickness.

The (absolute) standard deviation in nm is given, as is known, by the square root of the variance.

Iridium Content of the Catalyst

The iridium content and, if present, the content of ruthenium are determined by optical emission spectrometry with inductively coupled plasma (ICP-OES).

BET Surface Area

The BET surface area was determined with nitrogen as an adsorbate at 77 K in accordance with BET theory (multipoint method, ISO 9277:2010).

Atomic Ratio of Ir(IV) to Ir(III)

The relative proportions of the Ir atoms of oxidation state +4 and of oxidation state +3, and thus the atomic Ir(IV)/Ir(III) ratio in the supported iridium hydroxide oxide, were determined by X-ray photoelectron spectroscopy (XPS). This ratio is determined in the detail spectrum of the Ir(4f) doublet (BE 75-55 eV, Al-kα source) by means of a modified asymmetric Lorentzian peak fit with Shirley background. In addition, the presence of an IrOH species in the O(1s) detail spectrum (BE approx. 531 eV, Al-kα source) is also detected by means of an asymmetric peak fit (Shirley background, Gauss-Lorentz mixture with 30% Gaussian content). A corresponding procedure is described, e.g., in Abbott et al., Chem. Mater., 2016, 6591-6604.

XPS analysis can also be used to check whether iridium(0) is present in the composition.

The invention is explained in more detail with reference to the following examples.

### EXAMPLES

### Invention Example IE1

27.80 g of iridium(IV) chloride (IrCl₄ hydrate, Heraeus Deutschland GmbH & Co. KG) were dissolved in 4000 mL of water at room temperature. Next, 29.94 g of TiO₂ (DT20, Tronox, BET surface area: 20 m²/g) were added. The pH was adjusted to 10.3 by addition of NaOH. The aqueous medium was heated to 70° C. and the pH was adjusted to 11. It was stirred overnight at 70° C. The pH was maintained at >11.0. The TiO₂ support material loaded with the iridium-containing solid was filtered off, washed and dried. A one-hour thermal post-treatment was carried out at 350° C. in an oxygen-containing atmosphere. The catalyst comprises a core-shell structure. The XPS analysis showed that the iridium-containing coating present on the support material is an iridium hydroxide oxide. Ir(IV)/Ir(III) ratio: 4.0:1.0.

### Invention Example IE2

64.59 g of iridium(IV) chloride (IrCl₄ hydrate, Heraeus Deutschland GmbH & Co. KG) were dissolved in 2500 mL of water at room temperature. Next, 53.15 g of TiO₂ (DT30, Tronox, BET surface area: 30 m²/g) were added. The pH was adjusted to 9.0 by addition of NaOH. The aqueous medium was heated to 70° C. and the pH was adjusted to 9.2. It was stirred overnight at 70° C. The pH was maintained at >9.0. The TiO₂ support material loaded with the iridium-containing solid was filtered off, washed and dried. A one-hour thermal post-treatment was carried out at 350° C. in an oxygen-containing atmosphere. The catalyst comprises a core-shell structure. The XPS analysis showed that the iridium-containing coating present on the support material is an iridium hydroxide oxide. Ir(IV)/Ir(III) ratio: 3.9:1.0.

### Invention Example IE3

9.23 g of iridium(IV) chloride (IrCl₄ hydrate, Heraeus Deutschland GmbH & Co. KG) were dissolved in 1000 mL of water at room temperature. Next, 44.85 g of TiO₂ (DT-X5, Tronox, BET surface area: 5 m²/g) were added. The pH was adjusted to 9.0 by addition of NaOH. The aqueous medium was heated to 70° C. and the pH was adjusted to 9.2. It was stirred overnight at 70° C. The pH was maintained at >9.0. The TiO₂ support material loaded with the iridium-containing solid was filtered off, washed and dried. A one-hour thermal post-treatment was carried out at 350° C. in an oxygen-containing atmosphere. The catalyst comprises a core-shell structure. The XPS analysis showed that the iridium-containing coating present on the support material is an iridium hydroxide oxide. Ir(IV)/Ir(III) ratio: 4.6:1.0.

### Comparative Example CE1

48.35 g of iridium(IV) chloride (IrCI₄ hydrate, Heraeus Deutschland GmbH & Co. KG) were dissolved in 4000 mL of water at room temperature. Next, 51.9 g of TiO₂ (Activ G5, Evonik, BET surface area: 150 m²/g) were added. The pH was adjusted to 11.2 by addition of NaOH. The aqueous medium was heated to 70° C. and the pH was adjusted to >11. It was stirred overnight at 70° C. The pH was maintained at >11. The TiO₂ support material loaded with the iridium-containing solid was filtered off, washed and dried. A one-hour thermal post-treatment was carried out at 350° C. in an oxygen-containing atmosphere. Isolated iridium-containing islands are present on the support material. The XPS analysis showed that the isolated iridium-containing islands present on the support material contain an iridium hydroxide oxide.

The iridium content of the catalysts and the average layer thicknesses of the iridium-containing coating present on the support material are summarized in table 1 below.

Table 2 summarizes the BET surface areas of the support materials. In addition, table 2 calculates, for each of the samples and based on the relevant BET surface area of the support material and using the relationship

(1.505 (g/m²)×BET)/(1+0.0176 (g/m²)×BET)≤Ir-G≤(4.012 (g/m²)×BET)/(1+0.0468 (g/m²)×BET),
the iridium content range according to the claims. In the inventive samples IE1, IE2 and IE3, the BET surface areas of the support material and the iridium content of the catalyst are matched to one another such that the inventive relationship is satisfied. In the comparative material CE1, an iridium content is used which is too low with respect to the BET surface area of the support material.

TABLE 1
Iridium content of the catalysts and average
thickness of the Ir-containing coatings

| | Iridium content of | |
|---|---|---|
| | the catalyst | Average thickness of the Ir- |
| Sample | [% by weight] | containing coating [nm] |
| IE1 | 30 | 2.7 |
| IE2 | 35 | 3.0 |
| IE3 | 10 | 2.8 |
| CE1 | 30 | No coating, but only isolated |
| | | iridium hydroxide oxide islands |
| | | dispersed on the surface of the |
| | | support material. |

In samples IE1 to IE3, the relative standard deviation of the average thickness of the iridium-containing coating is at most 20%.

TABLE 2
BET surface area of the support materials
and iridium content of the catalysts

| | | | Range for iridium |
|---|---|---|---|
| | BET surface area | | content (in % by |
| | of the support | Iridium content | weight) given by the |
| | material | of the catalyst | relationship⁽¹⁾ |
| Sample | [m²/g] | [% by weight] | according to the claims. |
| IE1 | 20 | 30 | 22-41 |
| IE2 | 30 | 35 | 30-50 |
| IE3 | 5 | 10 | 7-16 |
| CE1 | 150 | 30 | 62-75 |

⁽¹⁾(1.505 (g/m²) × BET)/(1 + 0.0176 (g/m²) × BET) ≤ Ir-G ≤ (4.012 (g/m²) × BET)/(1 + 0.0468 (g/m²) × BET)

Production of Coated Membrane and Determination of Activity

The catalyst materials produced in examples IE1, IE2, IE3 and CE1 were used for the production of coated membranes. To this end, the catalyst materials of examples IE1, IE2, IE3 and CE1 were dispersed in an ink and applied to a membrane containing a sulfonic acid group-containing fluorinated polymer, in order to form the anode.

The coating was achieved by what is referred to as a decal method of transferring PTFE transfer films onto the polymer membrane (Nafion 117, 178 μm, Chemours). The coating of the PTFE film was carried out using a Mayer Bar coating machine. 5 cm² decals were punched out of the dried layers and pressed onto the polymer membrane under pressure (2.5 MPa) and temperature (155° C.). The loading was determined by weighing the PTFEs before and after the transfer process.

For each of the coated membranes, the cell voltage was determined as a function of the current density.

The test procedures for IE1, IE2, IE3 and CE1 are identical and were carried out in an automated manner in an on-site measurement setup. The current-voltage management was controlled with a potentiostat and booster (Autolab PGSTAT302N and Booster 10A from Metrohm). After a warm-up phase and a conditioning step, galvanostatic polarization curves were recorded in the current density range of 0.01-2.00 A/cm² at a cell temperature of 80° C.

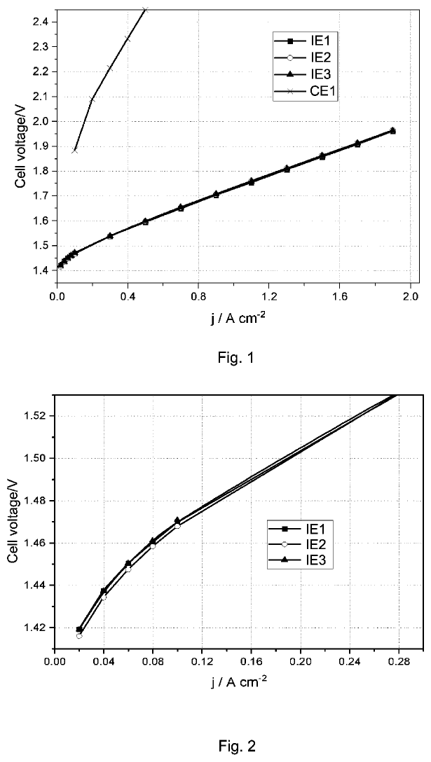

At each current point, a cell voltage was determined which corresponds to an averaged value over a period of 10 seconds after equilibrium was set. FIG. 1 shows the measurement curves (cell voltage as a function of the current density for IE1, IE2, IE3 and CE1). FIG. 2 also shows an increase in the relevant range for IE1, IE2 and IE3 from FIG. 1. In parallel, the high-frequency resistance was determined by electrochemical impedance spectroscopy measurements at the specified current points, so that the cell resistance could be corrected (IR-free). These curves are not shown.

The results are summarized in table 3.

TABLE 3
Properties of the coated membranes

| | Degree of iridium | | |
|---|---|---|---|
| Sample used for the | loading of the | Activity at | Activity at |
| production of the | anode [mg Ir/cm² | 1.50 V | 1.45 V_{IR-free} |
| coated membrane | of membrane] | [A/g of Ir] | [A/g of Ir] |
| IE1 | 0.25 | 764 | 399 |
| IE2 | 0.25 | 764 | 440 |
| IE3 | 0.29 | 641 | 345 |
| CE1 | 0.27 | Performance | Performance |
| | | not high | not high |
| | | enough to be | enough to be |
| | | measurable. | measurable. |

The results show that the catalyst according to the invention makes it possible to produce an anode which has a very low surface-based iridium loading (less than 0.30 mg of iridium per cm² of coated membrane surface) and nevertheless has very high electrochemical activity.

1. A particulate catalyst, comprising:
a support material; and,
an iridium-containing coating which is provided on the support material and which contains an iridium oxide, an iridium hydroxide, or an iridium hydroxide oxide,
wherein the support material comprises a BET surface area in the range from 2 m²/g to 50 m²/g; and,
the iridium content of the catalyst satisfies the following condition:
(1.505 (g/m²)×BET)/(1+0.0176 (g/m²)×BET)≤Ir-G≤(4.012 (g/m²)×BET)/(1+0.0468 (g/m²)×(BET), where:
BET is the BET surface area, in m²/g, of the support material; and,
Ir-G is the iridium content, in % by weight, of the catalyst.

2. A particulate catalyst, comprising:
a support material; and,
an iridium-containing coating which is provided on the support material; and which:
contains an iridium oxide, an iridium hydroxide or an iridium hydroxide oxide or a mixture of at least two of these iridium compounds; and,
has an average layer thickness in the range from 1.5 nm to 5.0 nm,
wherein the catalyst comprises an iridium content of at most 50% by weight.

3. The particulate catalyst according to claim 1, wherein the iridium content of the catalyst is at most 40% by weight, more preferably at most 35% by weight.

4. The particulate catalyst according to claim 1, wherein the BET surface area of the support material is 2 m²/g to 40 m²/g, more preferably 2 m²/g to <10 m²/g, even more preferably 2 m²/g to 9 m²/g.

5. A particulate catalyst, comprising:
a support material that comprises a BET surface area in the range from 2 m²/g to <10 m²/g, more preferably 2 m²/g to 9 m²/g; and,
an iridium-containing coating which is provided on the support material and which contains: an iridium oxide, an iridium hydroxide, or an iridium hydroxide oxide, or a mixture of at least two of these iridium compounds,
wherein the catalyst comprises an iridium content of 5% by weight to 20% by weight, more preferably 5% by weight to 14% by weight.

6. The particulate catalyst according to claim 1, wherein the iridium content of the catalyst satisfies the following condition:
(1.705 (g/m²)×BET)/(1+0.0199 (g/m²)×BET)≤Ir-G≤(3.511 (g/m²)×BET)/(1+0.0410 (g/m²)×(BET); where:
BET is the BET surface area, in m²/g, of the support material; and,
Ir-G is the iridium content, in % by weight, of the catalyst.

7. The particulate catalyst according to claim 1, wherein the average layer thickness of the iridium-containing coating is 1.5 nm to 4.0 nm, more preferably 1.7 nm to 3.5 nm.

8. The particulate catalyst according to claim 1, wherein the catalyst particles comprise a core-shell structure in which the support material forms the core and the iridium-containing coating forms the shell.

9. The particulate catalyst according to claim 1, wherein the iridium is exclusively present as iridium in the +3 oxidation state (iridium(III)) and/or as iridium in the +4 oxidation state (iridium(IV)).

10. The particulate catalyst according to claim 1, wherein the
support material is an oxide of a transition metal, an oxide of a main group metal, SiO₂ or a mixture of two or more of the aforementioned support materials.

11. The particulate catalyst according to claim 10, wherein the support material is a titanium oxide.

12. The particulate catalyst according to claim 1, wherein the catalyst has been subjected to thermal treatment at a temperature of more than 250° C., preferably >250° C. to 550° C., more preferably 300-450° C., even more preferably 300-380° C.; or the iridium-containing coating has an atomic ratio of iridium(IV) to iridium(III), determined by means of X-ray photoelectron spectroscopy (XPS), in the range from 1.9/1.0 to 4.7/1.0.

13. A method for producing the particulate catalyst according to claim 1, wherein an iridium-containing coating containing an iridium oxide, an iridium hydroxide or an iridium hydroxide oxide is deposited on a support material.

14. The method according to claim 13, wherein the coated support material is subjected to thermal treatment at a temperature of more than 250° C., preferably >250° C. to 550° C., more preferably 300-450° C., even more preferably 300-380° C.

15. A composition, containing
the particulate catalyst according to claim 1; and,
an ionomer, in particular a sulfonic acid group-containing ionomer.

16. A use of the particulate catalyst according to claim 1 as an anode for water electrolysis.

17. The particulate catalyst according to claim 2, wherein the iridium content of the catalyst is at most 40% by weight, more preferably at most 35% by weight.

18. A use of the particulate catalyst of the composition according to claim 15 as an anode for water electrolysis.
